(19) United States
(12) Patent Application Publication
(10) Pub. No.: US 2026/0039586 A1
(43) Pub. Date: Feb. 5, 2026

(54) PARALLEL COMMUNICATION ACROSS A PLURALITY OF TRANSPORT LINKS IN COMMUNICATION NETWORKS

(71) Applicant: VIASAT, INC., Carlsbad, CA (US)

(72) Inventors: Theodore A. Suszczynski, Vista, CA (US); William R. Costanza, Oceanside, CA (US)

(73) Assignee: VIASAT, INC., Carlsbad, CA (US)

(21) Appl. No.: 19/473,167

(22) PCT Filed: Apr. 6, 2023
(86) PCT No.: PCT/US2023/017789

§ 371 Date: Oct. 7, 2025

(51) Int. Cl. H04L 45/24; H04L 43/0811; H04L 43/0882; H04W 80/06

(52) U.S. Cl. CPC H04L 45/24; H04L 43/0811; H04L 43/0882; H04W 80/06

(57) ABSTRACT

Technologies are disclosed that provide for parallel communication paths across a plurality of transport links in a communications network, such as a tactical network. Parallel communication can be provided using parallel tunnels and parallel subflows. Individual packets can be directed along individual transport links based at least in part on the transport layer protocol associated with the packet. For network traffic sent using the transport control protocol (TCP), the network traffic can be divided into subflows with individual subflows being directed along individual transport links (e.g., using MPTCP). For network traffic sent using the user datagram protocol (UDP), the network traffic can be directed along individual tunnels established on respective transport links using virtual private network (VPN) technology over parallel communication paths (e.g., a multipath virtual private network (MPVPN)).

### BACKGROUND

### Field

The present disclosure generally relates to parallel communication across a plurality of transport links in a communication network.

### Description of Related Art

Tactical networks are used to establish communications between various systems such as military systems and other government and national defense systems. These systems typically have access to multiple different types of communication paths using radiofrequency (RF) communications systems. These communication paths can be provided by tactical data links and equipment can be used that provide interoperability among differing transport links. Tactical networks typically offer secure network communications and can be used for the transmission and exchange of tactical data among partners. Examples of communication networks that use transport links include KR20210129872 to KT CORP. which discloses a method and apparatus for high precision data communication, U.S. Pub. No. 2019/0387451 to KUCERA et al. which discloses methods and network elements for multi-connectivity control, and U.S. Pub. No. 2020/0245162 to DION which discloses network path reliability.

### SUMMARY

According to a number of implementations, the present disclosure relates to a method for multipath aggregation in a communications system that includes a plurality of transport links between an edge router and an aggregation hub, the method including: receiving network traffic from a network device; identifying a transport layer protocol associated with the network traffic; responsive to identifying connection-oriented traffic in the network traffic: establishing a plurality of subflows over the plurality of transport links; and transmitting the connection-oriented traffic in parallel over the plurality of transport links using the plurality of subflows; and responsive to identifying connectionless traffic in the network traffic: establishing a secure tunnel for each the plurality of transport links; determining a transport link of the plurality of transport links for each packet of the connectionless traffic based at least in part on a weighted algorithm comprising weights associated with a congestion level of the associated transport link; and transmitting the connectionless traffic in parallel over the plurality of transport links using the corresponding plurality of secure tunnels.

In some implementations, the weighted algorithm is a round-robin weighted algorithm. In some implementations, the method further includes receiving transmitted network traffic including the transmitted connectionless traffic and the transmitted connection-oriented traffic. In some implementations, the method further includes directing the transmitted connectionless traffic and the transmitted connection-oriented traffic to a destination network device. In some implementations, the method further includes, after receiving the transmitted network traffic, reordering packets of the transmitted network traffic to match a packet order of the network traffic prior to being transmitted over the plurality of transport links. In some implementations, the method further includes combining subflows of the transmitted connection-oriented traffic into a transmitted connection-oriented traffic flow.

In some implementations, the plurality of transport links has a difference in latency that is less than or equal to about 2 seconds. In some implementations, the method further includes terminating a connection-oriented flow from the network device by acting as an end point for the network device. In some implementations, the connection-oriented traffic includes transport control protocol (TCP) traffic. In some implementations, the connectionless traffic includes user datagram protocol (UDP) traffic.

According to a number of implementations, the present disclosure relates to an edge router in a communications system that includes a plurality of transport links between the edge router and an aggregation hub, the edge router including: a transport layer protocol sorter configured to analyze network traffic received from a user device to determine a transport layer protocol associated with the network traffic; a multipath transport control protocol (MPTCP) module configured to receive connection-oriented traffic from the transport layer protocol sorter; a multipath virtual private network (MPVPN) module configured to receive connectionless traffic from the transport layer protocol sorter; a plurality of network interfaces configured to communicate with the plurality of transport links; a data store storing computer executable instructions; and a processor configured to control operation of the data store, the plurality of network interfaces, the transport layer protocol sorter, the MPTCP module, and the MPVPN module, the processor configured execute the computer executable instructions to: establish a plurality of subflows over the plurality of transport links for the connection-oriented traffic using the MPTCP module; establish a secure tunnel for each the plurality of transport links using the MPVPN module; assign packets to individual transport links of the plurality of transport links using one or more congestion control algorithms with at least one congestion control algorithm being specific to an individual transport link based on characteristics of the individual transport link; transmit the connection-oriented traffic in parallel over the plurality of transport links using the plurality of subflows; and transmit the connectionless traffic in parallel over the plurality of transport links using the corresponding plurality of secure tunnels.

In some implementations, the connectionless traffic includes user datagram protocol (UDP) traffic. In some implementations, the connection-oriented traffic includes transport control protocol (TCP) traffic.

In some implementations, execution of the computer executable instructions further causes the processor to terminate a connection-oriented flow with a network device that sent the network traffic to the edge router by acting as an endpoint of the connection-oriented flow for the network device. In some implementations, execution of the computer executable instructions further causes the processor to assign packets of the network traffic to individual transport links to transmit the network traffic in parallel over the plurality of transport links.

According to a number of implementations, the present disclosure relates to an aggregation hub in a communications system that includes a plurality of transport links between an edge router and the aggregation hub, the aggregation hub including: a multipath transport control protocol (MPTCP) module configured to receive a plurality of connection-oriented subflows over the plurality of transport links; a multipath virtual private network (MPVPN) module configured to receive a plurality of connectionless packets over the plurality of transport links; a transport layer protocol sorter configured to forward network traffic reassembled by the MPTCP module and the MPVPN module to a destination network device; a plurality of network interfaces configured to communicate with the plurality of transport links; a data store storing computer executable instructions; and a processor configured to control operation of the data store, the plurality of network interfaces, the transport layer protocol sorter, the MPTCP module, and the MPVPN module, the processor configured execute the computer executable instructions to: reassemble the plurality of connection-oriented subflows to generate a connection-oriented flow using the MPTCP module; reorder the plurality of connectionless packets to generate a connectionless flow using the MPVPN module; and forward network traffic to the destination network device, the network traffic including the connection-oriented flow and the connectionless flow.

In some implementations, execution of the computer executable instructions further causes the processor to establish a TCP connection with the destination network device using the MPTCP module. In some implementations, execution of the computer executable instructions further causes the processor to buffer the plurality of connectionless packets using the MPVPN module prior to reordering the plurality of connectionless packets. In some implementations, a size of a buffer is adjusted by the MPVPN module based on a latency difference between the plurality of transport links and a throughput of the plurality of transport links.

In some implementations, the connection-oriented flow includes transport control protocol (TCP) flow. In some implementations, the connectionless flow includes user datagram protocol (UDP) flow.

According to a number of implementations, the present disclosure relates to a method of managing multipath transport control protocol (MPTCP) subflows in a communications system that includes a plurality of transport links between a first router and a second router, the method including: establishing a TCP session with a network device in communication with the second router; establishing a primary subflow using a first transport link of the plurality of transport links, the primary subflow established using a routing table; establishing a subsidiary subflow using a second transport link of the plurality of transport links; monitoring each of the plurality of transport links to determine that a transport link has been disconnected from the communications system; and responsive to determining that a transport link has been disconnected, removing the disconnected transport link from the routing table.

In some implementations, the routing table allocates an equal cost for each of the plurality of transport links prior to establishing the primary subflow. In some implementations, monitoring each of the plurality of transport links includes implementing one or more routing protocols to send messages over the plurality of transport links to determine that a transport link has been disconnected from the communications system. In some implementations, a transport link is determined to have been disconnected responsive to a message of the one or more routing protocols failing to be sent over the corresponding transport link. In some implementations, monitoring each of the plurality of transport links includes querying network equipment of each of the plurality of transport links to determine that a corresponding transport link can reach the second router to determine that the corresponding transport link has been disconnected from the communications system. In some implementations, a transport link is determined to have been disconnected responsive to the network equipment of the corresponding transport link responding that the network equipment cannot communicate with the second router.

For purposes of summarizing the disclosure, certain aspects, advantages and novel features have been described herein. It is to be understood that not necessarily all such advantages may be achieved in accordance with any particular embodiment. Thus, the disclosed embodiments may be carried out in a manner that achieves or optimizes one advantage or group of advantages as taught herein without necessarily achieving other advantages as may be taught or suggested herein.

### BRIEF DESCRIPTION OF THE DRAWINGS

FIG. 1A illustrates an example communications system that is configured to transfer data in parallel over a plurality of transport links between an edge router and an aggregation hub.

FIG. 1B illustrates the transmission of packets over the transport links in the communications system of FIG. 1A to demonstrate packet ordering over similar transport links.

FIG. 2 illustrates an example multipath aggregation system, similar to the communications system of FIG. 1A.

FIG. 3 illustrates an example of an edge router that can be used in any of the communications systems disclosed herein.

FIG. 4 illustrates an example aggregator that can be used in any of the communications systems described herein.

FIG. 5 illustrates an example router that can be used in any of the communications systems described herein.

FIG. 6 illustrates a flow chart of an example method for multipath aggregation in a communications system.

FIG. 7 illustrates a flow chart of an example method for multipath aggregation in a communications system.

FIG. 8 illustrates a flow chart of an example method for managing MPTCP subflows in a communications system.

FIG. 9 illustrates a flow chart of another example method for managing MPTCP subflows in a communications system.

### DETAILED DESCRIPTION OF SOME EMBODIMENTS

The headings provided herein, if any, are for convenience only and do not necessarily affect the scope or meaning of the claimed invention.

### Overview

Tactical networks use tactical data links to establish communications between various systems such as military systems, government systems, and national defense systems. These systems typically have access to multiple different types of communication paths, but no mechanism to allow data flows to be transmitted across multiple paths concurrently or in parallel. This is suboptimal because it does not take advantage of the available network capacity.

Accordingly, disclosed herein are systems, devices, and methods that provide for parallel communication paths across a plurality of transport links in a communications network, such as a tactical network. Parallel communication can be provided using parallel tunnels and parallel subflows. Individual packets can be directed along individual transport links based at least in part on the transport layer protocol associated with the packet. For network traffic sent using a transport layer protocol that utilizes a handshake to establish a connection between a client and a destination in a network (a connection-oriented protocol), such as the transport control protocol (TCP), the network traffic can be divided into subflows with individual subflows being directed along individual tunnels established on respective transport links. In some implementations, this can be accomplished using multipath TCP (MPTCP). For network traffic sent using different transport layer protocols (connectionless protocols), such as the user datagram protocol (UDP), the network traffic can be directed along the individual tunnels established on the respective transport links. In some implementations, this can be accomplished on a packet-by-packet basis. In some implementations, this can be accomplished using virtual private network (VPN) technologies over parallel communication paths, referred to herein as a multipath virtual private network (MPVPN).

The disclosed communications systems utilize a plurality of transport links with an edge router implemented on a client-side of the communications system and an aggregation hub implemented on a server-side of the communications system. The edge router and the aggregation hub are each a router in the communications system. Each router (e.g., the edge router and the aggregation hub) includes an MPTCP module, an MPVPN module, and a transport layer protocol sorter. Each router uses a combination of the MPTCP module and the MPVPN module to establish tunnels over the plurality of transport links between the edge router and the aggregation hub to transfer network packets. For example, an edge router can establish a tunnel to an aggregation hub over each transport or wide area network link. These tunnels can be considered underlay tunnels.

Upon receiving network traffic at the edge router, the transport layer protocol sorter can direct connection-oriented traffic (e.g., TCP traffic) to the MPTCP module and connectionless traffic (e.g., UDP traffic) to the MPVPN module for parallel transmission over the plurality of tunnels to the aggregation hub. Return network traffic is transmitted from the aggregation hub to the edge router using the same or similar methods. That is, connection-oriented traffic is directed to the MPTCP module, connectionless traffic is directed to the MPVPN module, and the network traffic is transmitted in parallel over the plurality of tunnels to the edge router.

In some implementations, each of the plurality of transport links in the communications system has similar characteristics, such as latency. This may be particularly beneficial when implementing MPTCP across the plurality of transport links to accomplish multipath aggregation of network traffic. In some implementations, individual transport links of the plurality of transport links in the communications system have different characteristics, such as latency or throughput. For example, the technologies disclosed herein may be beneficial in systems where the difference in latency between transport links is greater than or equal to about 100 ms and/or less than or equal to about 2 seconds.

As used herein, multipath aggregation can refer to aggregating multiple communication paths (e.g., across transport links) to function as a unified communication path for network traffic between routers in a communications system. Thus, the disclosed systems provide multipath aggregation by combining a plurality of physical transport links into one logical link to realize increased throughput and/or resiliency to degradation on an individual transport link. MPTCP can be used to accomplish multipath aggregation due at least in part to the MPTCP module handling connection-oriented sessions across the plurality of transport links. Other types of network packets (e.g., connectionless network traffic) are handled by the MPVPN module that is configured to route packets over tunnels across the plurality of transport links.

In typical communications systems with a plurality of parallel transport links, a primary communication path with one or more secondary communication paths can be selected but the network traffic only flows over a single communication path at a time. In contrast, the disclosed technologies enable routers to send network data on a packet-by-packet basis in parallel over different communication paths.

Furthermore, alternative protocols aside from MPTCP may be implemented in typical communications systems to enable more efficient use of parallel transport links. For example, typical communications systems may implement a weighted round-robin method to move packets down separate communication paths. This requires the ability to assign weights to the different communication paths by measuring their performance. This can (a) require that packets be sent over each communication path to perform measurement resulting in less available capacity (e.g., it adds overhead), (b) the weights may need to be adjusted frequently depending on the mobility of the system, and (c) if a link is lost, the weighting may not immediately account for this, resulting in packet loss. These disadvantages are ameliorated or eliminated with MPTCP as implemented in the disclosed communications systems.

In some implementations, the disclosed technologies can be implemented in software defined network (SDN) routers. The routers are configured to leverage the MPTCP protocol to enable reliable and transparent communications over any combination of transport links, including but not limited to, WiFi, cellular, satellite, tactical network transport devices (such as MANET radios, UHF, Microwave, Free Space Optics, SATCOM), and the like. In some embodiments, the routers implement MPTCP with radio or modem awareness, where status information from the radio or modem is used to determine the MPTCP primary subflow. In some embodiments, the routers implement MPTCP while enabling non-TCP (e.g., UDP) traffic to be transported over multiple paths simultaneously by leveraging VPN technology and tunnels to transport the data. In some embodiments, the routers are configured to reorder network traffic to ensure compatibility with encryptor devices (e.g., Internet protocol encryptor devices such as IPsec encryptor devices). It should be understood that although reference is made to tactical networks, the disclosed technologies can be used in a variety of communications systems that utilize multiple, parallel transport links between network entities (e.g., routers, hubs, etc.).

### Example Communications Systems

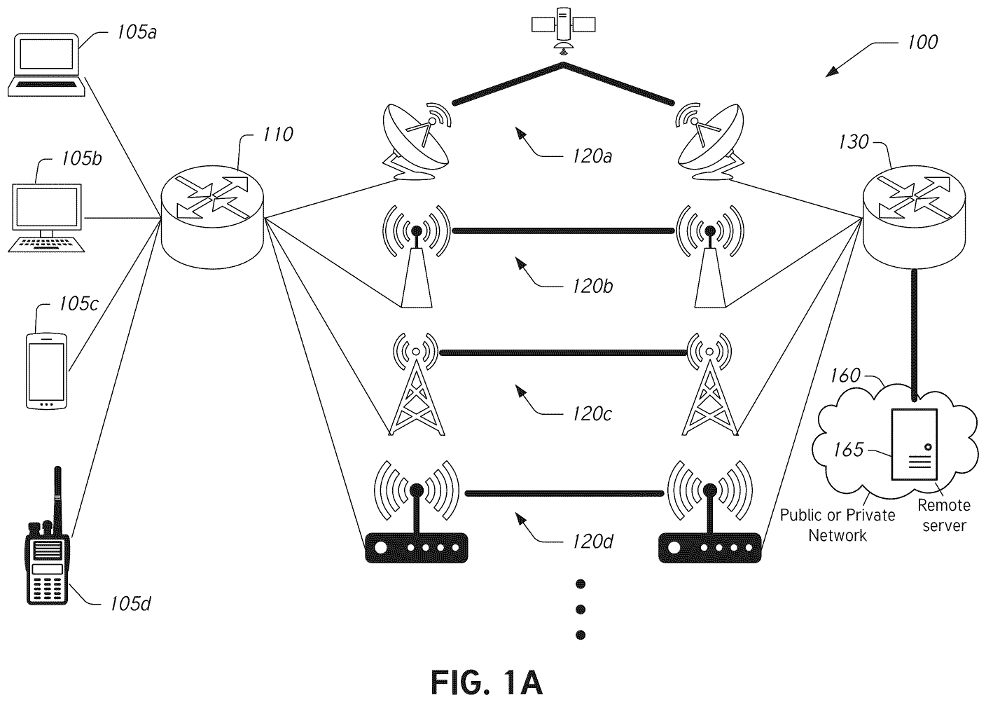

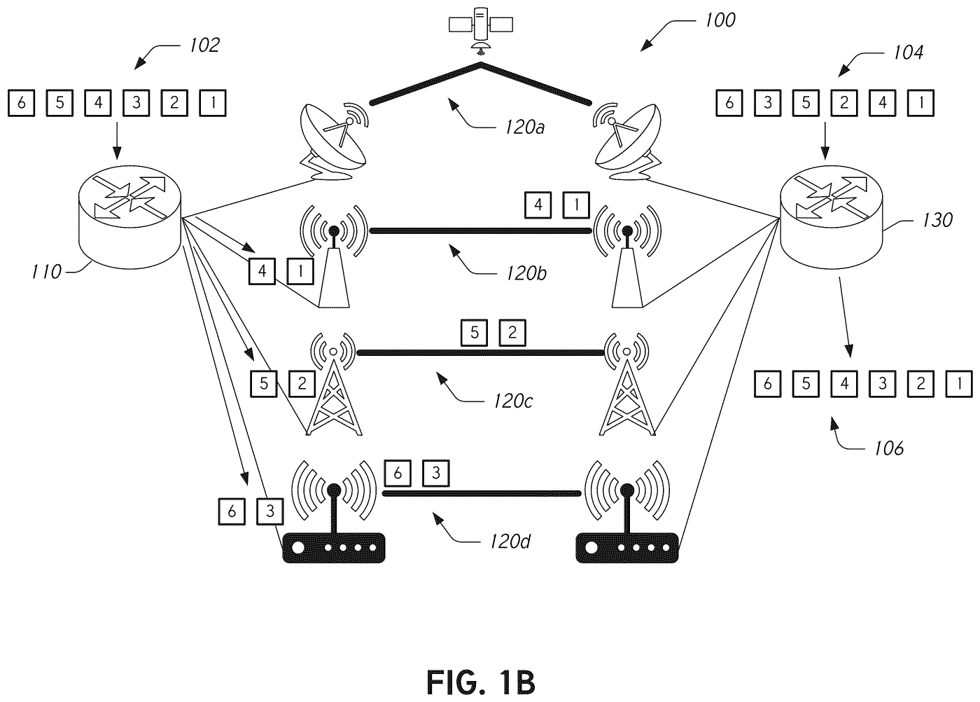

FIG. 1A illustrates an example communications system 100 that is configured to transfer data in parallel over a plurality of transport links 120a-120d between an edge router 110 and an aggregation hub 130. The edge router 110 and the aggregation hub 130 are configured to use MPTCP and MPVPN to effectively aggregate communication paths, through the transport links 120a-120d. The edge router 110 and the aggregation hub 130 are configured to send data on a packet-by-packet basis over different communication paths using MPTCP and MPVPN.

The communications system 100 is configured to direct network traffic between a plurality of user devices 105a-105d and a remote server 165 in a public or private network 160 using the edge router 110, the aggregation hub 130, and the plurality of transport links 120a-120d between the edge router 110 and the aggregation hub 130. The plurality of user devices 105a-105d can be any of a variety of devices configured to communicate with the edge router 110 using wired and/or wireless means. The plurality of user devices 105a-105d can include, for example and without limitation, computers, cellular devices, smartphones, modems, radios, sensors, IoT devices, etc.

The plurality of transport links 120a-120d provide parallel communication paths between the edge router 110 and the aggregation hub 130. The plurality of transport links 120a-120d can be any suitable transport link and can include tactical data links, for example. The plurality of transport links 120a-120d can utilize any suitable communication protocol and equipment and can include, for example and without limitation, cellular communication, WiFi networking, microwave communication, satellite communication, and the like.

The edge router 110 is configured to receive network traffic from the plurality of user devices 105a-105d and to direct the network traffic to the aggregation hub 130 over the plurality of transport links 120a-120d. The edge router 110 aggregates multiple communication paths over the plurality of transport links 120a-120d using a combination of MPTCP and MPVPN, as described in greater detail herein. Similarly, the edge router 110 is configured to receive network traffic from the aggregation hub 130 and to direct the network traffic to the destination user device 105a-105d indicated in the network traffic. In some implementations, the edge router 110 is configured to dynamically route network traffic over the plurality of transport links 120a-120d, responding to changes in the plurality of transport links 120a-120d (e.g., a transport link falling out of communication, a new transport link being added to the communications system 100, etc.). In some implementations, the edge router 110 is configured to dynamically route traffic over the plurality of transport links 120a-120d using congestion control algorithms. In certain instances, individual congestion control algorithms can be tailored to individual transport links based at least in part on the characteristics of the transport link. For example, a satellite link with higher latency can use a congestion control algorithm tailored for satellite links and a lower latency link can use a congestion control algorithm tailored for lower latency links (such as a TCP congestion control algorithm).

The aggregation hub 130 is configured to receive network traffic from the edge router 110 over the plurality of transport links 120a-120d. The aggregation hub 130 aggregates multiple communication paths over the plurality of transport links 120a-120d using a combination of MPTCP and MPVPN, as described in greater detail herein. The aggregation hub 130 then forwards the network traffic to a target destination indicated by the network traffic, such as a remote server 165 on a public or private network 160 (e.g., the Internet). Similarly, the aggregation hub 130 is configured to receive network traffic from the remote server 165 and to direct the network traffic to the edge router 110 over the plurality of transport links 120a-120d. In some implementations, similar to the edge router 110, the aggregation hub 130 is configured to dynamically route network traffic over the plurality of transport links 120a-120d, responding to changes in the plurality of transport links 120a-120d (e.g., a transport link falling out of communication, a new transport link being added to the communications system 100, etc.). In some implementations, the aggregation hub 130 is configured to dynamically route traffic over the plurality of transport links 120a-120d using congestion control algorithms.

FIG. 1B illustrates the transmission of packets 102 over the transport links 120a-120d in the communications system 100 to demonstrate packet ordering over a plurality of transport links. The packets are ordered 1 through 6 to illustrate an example of ordered packets 102. First, the packets 102 are sent to the edge router 110 for transmission to the aggregation hub 130. Then, the edge router 110 determines which transport links to use for the transmission of the packets 102. The edge router 110 then directs packets over underlay tunnels between the edge router 110 and the aggregation hub 130 based on these determinations. For example, packets 1 and 4 are directed over the underlay tunnel established on the transport link 120b, packets 2 and 5 are directed over the underlay tunnel established on the transport link 120c, and packets 3 and 6 are directed over the underlay tunnel established on the transport link 120d. Due at least in part to the varying characteristics of the transport links 120b-120d (e.g., latency, jitter, throughput, etc.), the packets may arrive in a different order than originally transmitted, resulting in the disordered packets 104. Thus, to accommodate transport links with varying characteristics, the aggregation hub 130 is configured to reorder the packets at the underlay tunnel endpoints on the aggregation hub 130 prior to being forwarded, resulting in the reordered packets 106. A similar process is performed for network traffic travelling from the aggregation hub 130 back to the edge router 110. That is, the edge router 110 is also configured to reorder received packets at the underlay tunnel endpoints prior to forwarding the packets.

As described herein, some embodiments of the edge router 110 and/or the aggregation hub 130 include a decision engine that determines which transport links, and therefore which underlay tunnels, to use for transmission of network traffic (e.g., subflows and packets). The decision engine can be configured to analyze buffer sizes and/or to utilize congestion control algorithms in determining which transport link to use to transmit individual subflows or packets. In some embodiments, the decision engine can query the equipment of the transport links 120a-120d, such as the radios of the transport links, to determine the status of the equipment. The status of the equipment can include, for example and without limitation, throughput, latency, jitter, and the like. The status of the equipment can be used to drive metrics for weighting individual transport links in the decision algorithms employed by the decision engine. For example, a round-robin weighted algorithm can be used to determine which transport link to use, which may be particularly beneficial for connectionless network traffic (e.g., UDP traffic).

As described in greater detail herein, the edge router 110 is configured to provide bi-directional, secure connectivity between edge devices, such as the user devices 105a-105d, and the aggregation hub 130 using multiple and disparate wide area network (WAN) links simultaneously, such as the transport links 120a-120d. Furthermore, the aggregation hub 130 is configured to provide a centralized point to terminate secure tunnels to the edge router 110 (and other edge routers) and to relay user network traffic and system status to public networks (e.g., Internet), private networks (e.g., classified or non-classified private networks), data stores, and other target devices and systems. The communications system 100 utilizes a combination of MPTCP and MPVPN over tunnels established between the edge router 110 and the aggregation hub 130 to transfer network packets. The edge router 110 is configured to establish a tunnel to the aggregation hub 130 over each transport link 120a-120d. Each of these tunnels can be considered an underlay tunnel. The disclosed technologies can be implemented in virtualized and/or hardware router devices. The disclosed technologies can also be implemented in hybrid networking environments Hybrid networking environments can include, for example, multiple parallel communication paths at least two of which have different transport characteristics from each other.

### Examples of Multipath Aggregation Systems

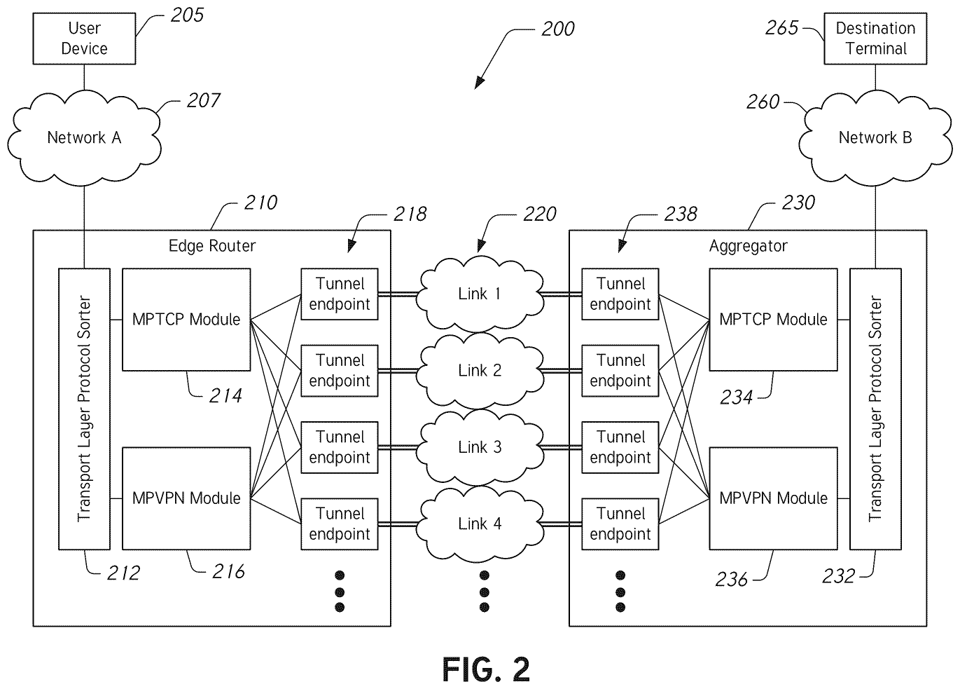

FIG. 2 illustrates an example multipath aggregation system 200, similar to the communications system 100 described herein with reference to FIG. 1A. For example, the multipath aggregation system includes an edge router 210 similar to the edge router 110 of FIG. 1A, an aggregator 230 similar to the aggregation hub 130 of FIG. 1A, and a plurality of transport links 220 similar to the transport links 120a-120d of FIG. 1A. Furthermore, similar to the communications system 100, the multipath aggregation system 200 is configured to connect a user device 205 (of network A 207) to a destination terminal 265 (of network B 260) using the edge router 210 and the aggregator 230 by aggregating the physical transport links 220 into a single logical link between the edge router 210 and the aggregator 230. The user device 205 is similar to the user devices 105a-105d of FIG. 1A and may be part of a private or public network, such as the network A 207. Similarly, the destination terminal is similar to the remote server 165 of FIG. 1A and may be part of a private or public network, such as the network B 260.

The edge router 210 includes a transport layer protocol sorter 212, an MPTCP module 214, an MPVPN module 216, and a plurality of tunnel endpoints 218 corresponding to the plurality of transport links 220 (e.g., there is a tunnel endpoint for each transport link). Similarly, the aggregator 230 includes a plurality of tunnel endpoints 238 corresponding to the plurality of transport links 220 (e.g., there is a tunnel endpoint for each transport link), an MPVPN module 236, an MPTCP module 234, and a transport layer protocol sorter 232.

When the user device 205 sends data to the destination terminal 265, the edge router 210 receives the packets through the network A 207. The edge router 210 is configured to receive the packets, determine the type of packet, and to direct the packet based on the protocol associated with the packet. In particular, the transport layer protocol sorter 212 analyzes the packet to identify the layer 4 (or transport layer) protocol of the packet. If the protocol is a connection-oriented protocol, such as TCP or SCTP, the packet is queued for processing by the MPTCP module 214. If the protocol is a connectionless protocol (or not a connection-oriented protocol), such as UDP or QUIC, the packet is queued for processing by the MPVPN module 216. A connection-oriented protocol can include a transport layer protocol with a multi-phase process to establish a connection between endpoints in a network, which may require a handshake protocol between the endpoints. A connectionless protocol can include a transport layer protocol with a single-phase process that includes transferring data, without requiring the establishment of a connection between the endpoints or without requiring a handshake protocol between the endpoints. Examples of transport layer protocols include TCP, UDP, QUIC, ESP, and SCTP.

The packets queued at the MPTCP module 214 are organized into subflows. A primary subflow can be established across one of the plurality of transport links 220 with one or more secondary or subsidiary subflows established across different transport links of the plurality of transport links 220. As described herein, the MPTCP module 214 can be configured to manage the subflows across the transport links 220, updating which transport links to use in case a transport link drops out and/or a transport link is added.

The MPTCP module 214 is configured to proxy the TCP session from the user device 205. The MPTCP module 214 is configured to create an MPTCP-capable session, which includes transmitting the TCP data from the user device 205 across the plurality of transport links 220 as MPTCP subflows. The MPTCP module 214 can be configured to provide functionality similar to a performance enhancing proxy (PEP). For example, the MPTCP module 214 can be configured to terminate a TCP network flow from the user device 205 client on network A 207. In such instances, the MPTCP module 214 can act as a proxy destination in the TCP handshake protocol in place of the user device 205. The MPTCP module 214 is also configured to create MPTCP subflows across two or more of the transport links 220. The MPTCP module 214 can also be configured to perform other processing on the network traffic, such as encryption. These techniques may also be implemented for other connection-oriented protocols.

The packets queued at the MPVPN module 216 can be directed in parallel across individual tunnels established on the plurality of transport links 220. The MPVPN module 216 assigns packets to individual transport links 220. The MPVPN module 216 can be configured to account for conditions of individual transport links 220 (e.g., throughput and latency) in assigning packets to individual transport links 220. For example, the MPVPN module 216 may use round-robin techniques weighted in accordance with current network conditions to assign network packets to individual transport links 220. For example, the weights in the round-robin weighted algorithm are associated with a congestion level of the associated transport link.

The MPVPN module 216 can be configured to determine the network capacity of each transport link 220 and to do a weighted round-robin for each transport link 220. The MPVPN module 216 can be configured to divide up the network traffic based on criteria such as latency, throughput, high availability (e.g., surety of arrival of data, low drop rates, etc.), and the like. The MPVPN module 216 is configured to implement the VPN protocol. Further, the MPVPN module 216 is configured to reorder packets to a correct order (e.g., the order in which they were sent) prior to processing by the VPN protocol where the VPN may be implemented, for example, on the user device 205 or internal to the edge router 210. This is advantageous because VPN protocols typically have replay windows (e.g., IPsec) and check for out-of-order packets. If there are packets that are out of order, the VPN protocol may treat the data as an attack, such as a replay attack. However, this may be undesirable behavior where parallel transport links are employed because packets may arrive out of order due to different latencies on different transport links. Thus, by correcting the order of the packets prior to processing by the VPN protocol, VPN protocols may continue to operate with their typical capabilities.

After processing by the MPTCP module 214 or the MPVPN module 216, network packets are directed to the tunnel endpoints 218 on the edge router 210. The tunnel endpoints 218 are communicatively coupled to the MPTCP module 214 and to the MPVPN module 216. The edge router 210 can include one secure tunnel endpoint 218 for each transport link 220. Thus, the MPTCP module 214 directs the MPTCP subflows in parallel along underlay tunnels between the edge router 210 and the aggregator 230 and the MPVPN module 216 directs packets from other transport protocols in parallel along underlay tunnels between the edge router 210 and the aggregator 230. In some embodiments, the transport links 220 are all of the same or similar type and/or the transport links 220 each have a similar latency. This may be particularly advantageous for TCP network traffic to establish and maintain a connection between the MPTCP module 214 and the destination terminal 265 while communicating data in parallel across the transport links 220. For example, transport links with large differences in latency may require buffering, and because TCP requires receiving ACKs as part of the communication protocol, failing to receive an ACK when it is expected may result in a request to resend the presumably missing packet. So, if one transport link has a relatively high latency and another link has a relatively low latency, the low latency transport link receives ACKs whereas the high latency transport link does not receive timely ACKs, which may require the buffer size to be increased, thereby decreasing throughput. In some implementations, the transport links 220 have different characteristics and the multipath aggregation system 200 may implement buffering to establish and maintain a connection between the MPTCP module 214 and the destination terminal 265 while communicating data in parallel across the transport links 220. For example, the multipath aggregation system 200 can be implemented where a maximum difference in latency (or delay skew) between individual transport links 220 is up to about 2 seconds and the multipath aggregation system 200 may be particularly beneficial where the delay skew is greater than or equal to about 100 ms and/or less than or equal to about 2 seconds.

The aggregator 230 includes a plurality of tunnel endpoints 238 for each secure tunnel associated with a transport link 220, the tunnel endpoints 238 being communicatively coupled to the MPTCP module 234 and to the MPVPN module 236. For each subflow from the edge router 210, the MPTCP module 234 is configured to put the subflows back together into a single flow corresponding to the network flow received from the user device 205. The MPTCP module 234 is also configured to connect to the destination terminal 265 on the network B 260. For each packet not included in a subflow, the MPVPN module 236 is configured to buffer and reorder the packets to achieve the same packet order as received from the user device 205 over the network A 207. For example, after receiving the transmitted network traffic, the MPVPN module 236 is configured to reorder the packets of the transmitted network traffic to match a packet order of the network traffic prior to being transmitted over the transport links 220. In some embodiments, the MPVPN module 236 is configured to control the size of the buffer based at least in part on the latency difference between the transport links 220, the throughput of the transport links 220, or other such characteristics of the transport links 220. For example, the throughput determines the rate of transmission and the latency difference determines how skewed the packets can be from each other, the buffer is therefore sized to accommodate a number of packets to account for the latency difference based on the throughput. By way of example, if the throughput is 100 packets per second and the latency difference (or delay skew) is 750 ms, the buffer can be sized to accommodate a minimum of 75 packets (750 ms×100 packets/second). The transport layer protocol sorter 232 can provide network address translation (NAT) as needed for the network traffic. The aggregator 230 thus directs the network traffic to the destination terminal 265.

For traffic from the destination terminal 265 to the user device 205, the aggregator 230 provides the network functionality described herein with reference to the edge router 210 and the edge router 210 provides the network functionality described herein with reference to the aggregator 230.

Because TCP is a host-to-host connection-based protocol (or a connection-oriented protocol), an established connection is required before transmitting data. TCP also requires creating, maintaining, and closing a connection as part of the protocol. For transferring data, when a source device transmits a packet, TCP requires the destination device to confirm receipt before any additional packets are sent. This can slow down network communication when using a high-latency transport link. To establish a connection, a client initiates a 3-step handshake: the client sends a SYN to the destination device; the destination device sends a SYN-ACK in response; and the client sends an ACK back to the destination device. Similarly, to terminate the connection, the client performs a 4-step handshake: the client sends a FIN packet; the destination device sends an ACK packet; the destination device sends a FIN packet; and the client sends an ACK packet. On the other hand, UDP is a communications-based protocol (or connectionless protocol) and operates process-to-process. UDP does not rely on connection agreements and does not require packet acknowledgment. UDP sends data packets before the destination device agrees and can continue to send packets one after another without confirmed delivery.

The MPTCP modules 214, 234 are configured to handle connection-oriented (e.g., TCP) network traffic, including managing the required handshake protocols, while the MPVPN modules 216, 236 are configured to handle connectionless (e.g., UDP) network traffic, both of which are configured to transmit data in parallel across the transport links 220. Thus, the multipath aggregation system 200 utilizes MPTCP with multipath VPN technology because MPTCP technology does not support UDP or other connectionless transport layer protocols. Accordingly, the multipath aggregation system 200 utilizes routers (e.g., the edge router 210 and the aggregator 230) with an MPTCP module and an MPVPN module to handle different transport layer protocols while still providing parallel communication over a plurality of transport links. The MPTCP modules 214, 234 can provide a bonding path over the transport links 220 and the MPVPN modules 216, 236 can provide the tunneling protocol over the transport links 220. The transport layer protocol sorters 212, 232 are configured to separate the network traffic out for the modules 214, 216, 234, 236.

As used herein, MPTCP includes protocols that enable the simultaneous use of a plurality of transport links through a modification of TCP that presents a regular TCP interface to applications, while in fact spreading data across several subflows. MPTCP can be configured to use multiple communication paths in parallel within a single logical connection and to keep the logical connection established when the address of the endpoint changes. MPTCP can be configured to manage a set of subflows, with each subflow being a TCP socket. This can be extended to other connection-oriented protocols as well.

The MPTCP module 214 can act as a performance enhancing proxy (PEP), which may also be referred to as TCP spoofing, and can be configured to intercede in the 3-way handshake of TCP between the user device 205 and the destination terminal 265. For example, the MPTCP module 214 can receive the SYN from the user device 205 and can respond to the user device 205 with the SYN/ACK packet. The user device 205 can then respond with the ACK packet and the first data packet, such as an HTTP request packet. The MPTCP module 214 can combine the original SYN packet and the first data packet and can send this to the MPTCP module 234 of the aggregator 230, thereby reducing the time taken to send the initial request from the user device 205 to the destination terminal 265. In some embodiments, the MPTCP module 214 acts as a SOCKS proxy for TCP traffic between the user device 205 and the destination terminal 265. This can be extended to other connection-oriented protocols as well.

### Examples of Edge Routers and Aggregators

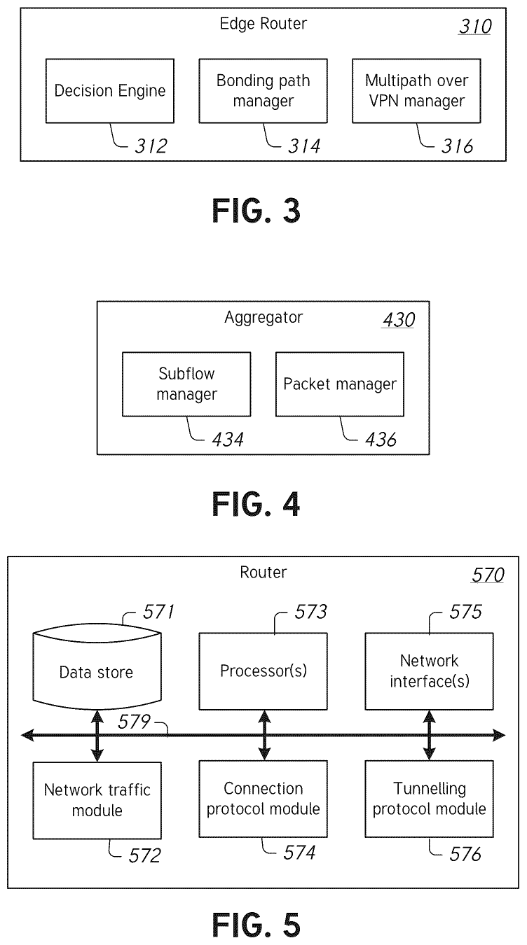

FIG. 3 illustrates an example of an edge router 310 that can be used in any of the communications systems disclosed herein. As used herein, an edge router can be a router located at a network boundary that enables an internal network to connect to external networks. The edge router 310 can be the edge router 110 in the communications system 100 and/or the edge router 210 in the multipath aggregation system 200. The edge router 310 includes a decision engine 312, a bonding path manager 314, and a multipath over VPN manager 316. The edge router is configured to manage connection-oriented network traffic using the bonding path manager 314 and to manage connectionless network traffic using the multipath over VPN manager 316. The decision engine 312 is configured to aid the bonding path manager 314 and the multipath over VPN manager 316 in directing network traffic over a plurality of transport data links communicatively coupled to the edge router 310.

Because the MPTCP protocol does not support connectionless transport layer protocols, the multipath over VPN manager 316 is configured to manage parallel transmission of network packets for these protocols while the bonding path manager 314 is configured to manage parallel transmission of subflows of connection-oriented network traffic. As a result, connection-oriented network traffic is transmitted as a plurality of subflows over a bonding path comprising the plurality of transport links and connectionless network traffic is transmitted on a packet-by-packet basis over multipath tunnels comprising the plurality of transport links.

The decision engine 312 can be configured to determine which transport link to use for individual MPTCP subflows and/or for connectionless network traffic. The decision engine 312 can be configured to analyze buffer sizes and to use congestion control algorithms to determine which transport link to use. In some embodiments, the edge router 310 (e.g., using the decision engine 312) can be configured to query radios in a communications system to determine the status of the radios. Based on the status, the decision engine 312 can determine which transport link to use. The status of the radios (or other network communication equipment such as satellite modems and other tactical devices) can include the throughput, latency, and the like. In some implementations, the status of the radios can be used in determining transport links to use based on a weighting algorithm. In some embodiments, querying the radio includes determining the perception of the network from the point of view of the radio. Weighting of the transport links can be adjusted based on the responses from the radios. In some implementations, network traffic may be designated as latency sensitive and the decision engine 312 can assign weights (e.g., lower or higher) to low latency transport links. Similarly, in some implementations, network traffic may be designated as throughput sensitive and the decision engine 312 can assign weights (e.g., lower or higher) to high throughput transport links.

Similarly, the edge router 310 (e.g., using the decision engine 312) can be configured to run a speed test analysis over each transport link to determine characteristics of the transport link. This can be done in addition to or as an alternative to querying the network equipment itself. Weighting of the transport links can be adjusted based on the results of the speed test analysis. Being able to determine changing network characteristics, e.g., by querying network equipment for their status and/or by running a speed test analysis over each transport link, may be advantageous over systems that assume the characteristics of transport links are static because it allows the edge router 310 to automatically react to changing network conditions.

The decision engine 312 can be configured to implement any of a variety of congestion control algorithms. For example, for a first transport link a congestion control algorithm can be implemented that is suitable for a satellite link and for a second transport link a TCP congestion control algorithm can be implemented that is suitable for a terrestrial link. Thus, the decision engine 312 can be configured to determine a congestion control algorithm for individual transport links based at least in part on the characteristics of the corresponding transport link.

The edge router 310 is configured to provide robust and resilient connectivity through the use of multiple, simultaneous communication paths. The edge router 310 is configured to bond disparate transport links and networks to enable robust and resilient connectivity across mobile networks, even in contested and congested environments. As described herein, the edge router 310 can be configured to be radio aware (e.g., by querying radios in the network) and to aggregate multiple transport links into a single logical link which allows the edge router 310 to adapt to changes in transport link status and to route or bond packets over available transport links, thereby bringing increased resilience and capacity. It should be noted that a configuration similar to that of the edge router 310 can also be used for the aggregation hub or aggregator, such as the aggregation hub 130 of FIG. 1A or the aggregator 230 of FIG. 2.

FIG. 4 illustrates an example aggregator 430 that can be used in any of the communications systems described herein. As used herein, an aggregator can be an aggregation platform that acts as a central connection point for distributed wide area network traffic that can then be sent to external networks, such as the Internet. The aggregator 430 can be the aggregation hub 130 in the communications system 100 and/or the aggregator 230 in the multipath aggregation system 200. The aggregator 430 includes a subflow manager 434 and a packet manager 436. The aggregator 430 is configured to manage connection-oriented network traffic using the subflow manager 434 and to manage connectionless network traffic using the packet manager 436. It should be noted that a configuration similar to that of the aggregator 430 can also be used for the edge router, such as the edge router 110 of FIG. 1A or the edge router 210 of FIG. 2.

The aggregator 430 can be configured to manage one or more subflows using the subflow manager 434. The subflow manager 434 can be configured to identify when the transport link associated with a primary subflow goes down to update routing tables to avoid network communication issues, examples of which are described herein. Similarly, the subflow manager 434 can be configured to assign subsidiary subflows to transport links based on congestion control algorithms, as disclosed herein. Similarly, the subflow manager 434 can be configured to receive network traffic using a primary subflow and one or more subsidiary subflows and to reassemble the subflows into a network flow for a destination device, as described herein.

The aggregator 430 can be configured to manage the transmission of network packets over secure tunnels using the packet manager 436. This can be used for connectionless network traffic and can leverage VPN technology to transmit and receive network packets over secure tunnels. The packet manager 436 can use this technology to transmit network packets in parallel over a plurality of transport links, as described herein. Similarly, the packet manager 436 can be configured to receive network packets from an edge router, for example, and to reorder the network packets to place them in a correct order prior to processing by any VPN or other such technologies. Once reordered, the packet manager 436 can be configured to forward the packets to a destination device.

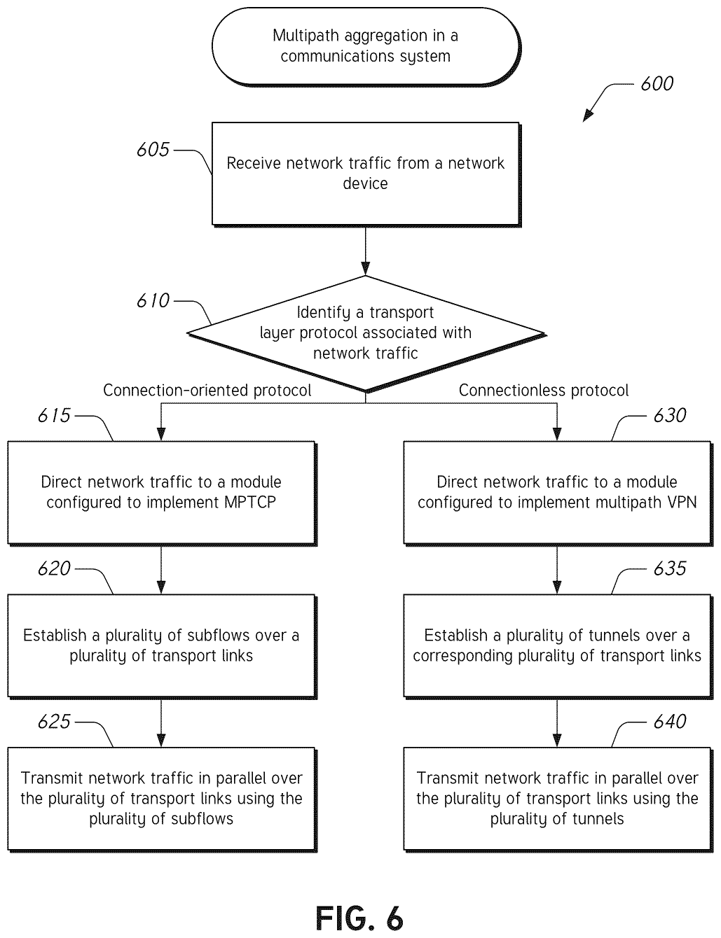

FIG. 5 illustrates an example router 570 that can be used in any of the communications systems described herein. For example, the router 570 can be the edge router 110 and/or the aggregation hub 130 of the communications system 100 or the router 570 can be the edge router 210 and/or the aggregator 230 of the multipath aggregation system 200. The router 570 can employ any method described herein associated with multipath aggregation, such as the example methods 600, 700, 800, and 900 described herein with reference to FIGS. 6-9, respectively.

The router 570 can include hardware, software, and/or firmware components for multipath aggregation and transmitting network traffic in parallel across a plurality of transport links. The router 570 includes a data store 571, one or more processors 573, one or more network interfaces 575, a network traffic module 572, a connection protocol module 574, and a tunnelling protocol module 576. Components of router 570 can communicate with one another, with external systems, and with other components of a network using communication bus 579. The router 570 can be implemented in a component of a network communications system. The router 570 can be implemented using one or more computing devices. For example, the router 570 can be implemented using a single computing device, multiple computing devices, a distributed computing environment, or it can be located in a virtual device residing in a public or private computing cloud. In a distributed computing environment, one or more computing devices can be configured to provide the modules 572, 574, 576 to provide the described functionality.

The router 570 includes a network traffic module 572 configured to receive network traffic from a user device or a destination terminal and to determine a transport layer protocol associated with the received network traffic. The router 570 also includes a connection protocol module 574 and a tunnelling protocol module 576. If the network traffic module 572 determines that the network traffic is associated with a connection-oriented protocol, such as TCP, the network traffic is queued for processing at the connection protocol module 574. All other network traffic is queued for processing at the tunnelling protocol module 576. The connection protocol module 574 can be configured to implement MPTCP technology, PEP technology, and/or SOCKS technology to manage multiple protocol connections (e.g., TCP) across a plurality of transport links. The tunnelling protocol module 576 can be configured to implement VPN technology to securely transmit network traffic over tunnels established on the plurality of transport links. This enables the router 570 to aggregate parallel transport links into a single logical link between routers in a communications system.

Similarly, the router 570 is configured to receive network traffic from another router in the communications system and to direct the received network traffic to a user device or destination terminal. Network traffic received from another router can be processed by the connection protocol module 574 for connection-oriented network traffic and by the tunnelling protocol module 576 for connectionless network traffic. The connection protocol module 574 is configured to reassemble subflows into network traffic and the tunnelling protocol module 576 is configured to reorder network packets. The reassembled and reordered network traffic can be forwarded to the user device or destination terminal using the network traffic module 572.

The network traffic module 572 can implement any functionality or algorithm described herein as being performed by a decision engine or transport layer protocol sorter. Similarly, the connection protocol module 574 can implement any functionality of algorithm described herein as being performed by an MPTCP module, a performance enhancing proxy, and/or a SOCKS proxy. Likewise, the tunnelling protocol module 576 can implement any functionality of algorithm described herein as being performed by an MPVPN module or a tunneling multipath VPN.

The router 570 includes one or more processors 573 that are configured to control operation of the modules 572, 574, 576 and the data store 571. The one or more processors 573 implement and utilize the software modules, hardware components, and/or firmware elements configured for multipath aggregation. The one or more processors 573 can include any suitable computer processors, application-specific integrated circuits (ASICs), field programmable gate array (FPGAs), or other suitable microprocessors. The one or more processors 573 can include other computing components configured to interface with the modules 572, 574, 576 and data store 571 of the router 570.

The router 570 includes the data store 571 configured to store configuration data, user requirements, network statuses, network characteristics and capabilities, control commands, databases, algorithms, executable instructions (e.g., instructions for the one or more processors 573), and the like. The data store 571 can be any suitable data storage device or combination of devices that include, for example and without limitation, random access memory, read-only memory, solid-state disks, hard drives, flash drives, bubble memory, and the like.

### Example Methods of Multipath Aggregation

FIG. 6 illustrates a flow chart of an example method 600 for multipath aggregation in a communications system. The method 600 can be performed by a communications system or any component of a communications system (e.g., edge routers, aggregation hubs, or aggregators) disclosed herein. Furthermore, any step or portion of a step of the method 600 can be performed by any suitable component of the communications system disclosed herein. Similarly, any combination of components of the communications system disclosed herein can perform any step or portion of a step of the method 600. However, for ease of description, the method 600 is described as being performed by a router, such as any of the routers disclosed herein including the edge router 110, the aggregation hub 130, the edge router 210, the aggregator 230, the edge router 310, the aggregator 430, and the router 570 described herein with reference to FIGS. 1A-5.

In block 605, the router receives network traffic from a network device. The network device can be a user device, a remote server, a destination terminal, or the like. The network device can be associated with a private or public network to which the router is communicatively coupled. The network traffic can be intended for a destination network device on a second network, the router communicatively coupled to the second network through a second router and a plurality of transport links that communicatively couple the router with the second router. In some embodiments, each transport link of the plurality of transport links has the same or similar network latency. In some embodiments, each transport link of the plurality of transport links is of the same or similar type. In some embodiments, individual transport links of the plurality of transport links have different network latencies. For example, the delay skew among the transport links can be greater than or equal to about 100 ms and/or less than or equal to about 2 seconds.

In block 610, the router identifies a transport layer protocol associated with network traffic. The router is configured to separate network traffic that uses a connection-oriented protocol, such as TCP traffic, from connectionless network traffic. Depending on the transport layer protocol, the router either directs network traffic to a module configured to implement multipath TCP technology or to a module configured to implement multipath VPN technology.

In block 615, the router directs TCP network traffic to a module configured to implement MPTCP. In some embodiments, the router directs network traffic utilizing any connection-oriented protocol to the module configured to implement MPTCP. In some embodiments, the module configured to implement MPTCP is also configured to intercede in a handshake protocol configured to establish a connection between the network device and the destination network device, as described herein. For example, the module configured to implement MPTCP can be configured to terminate a TCP flow from the network device, acting as the end point for the TCP flow. In some embodiments, the module configured to implement MPTCP is also configured to perform other encryption on the TCP traffic, such as encryption.

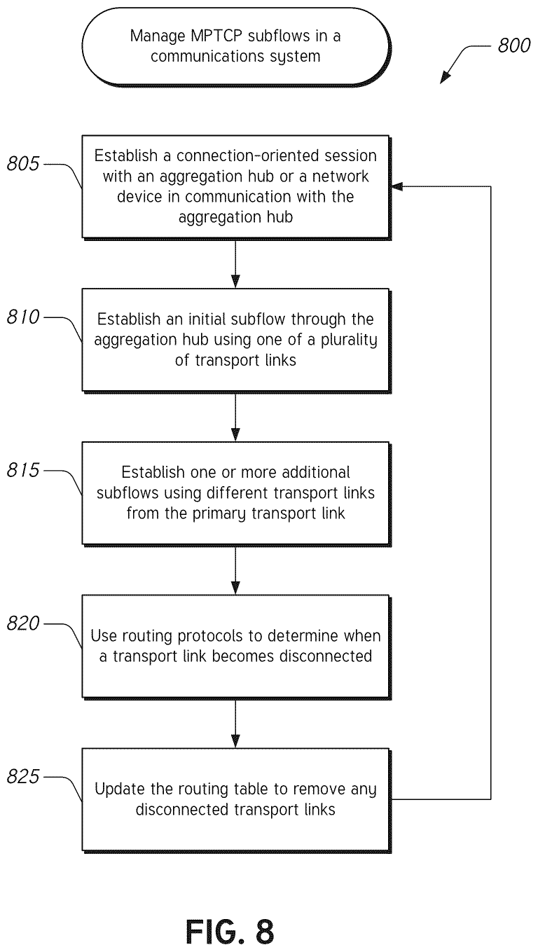

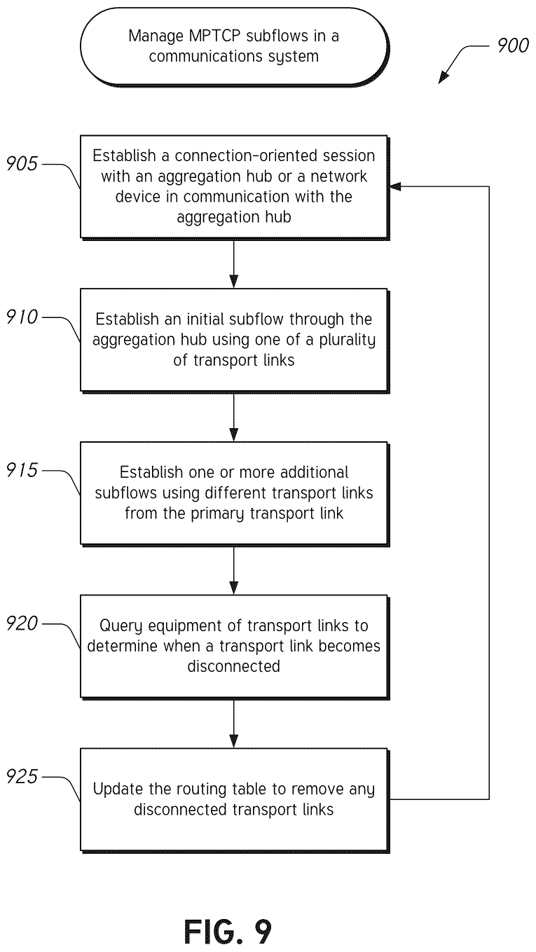

In block 620, the router establishes a plurality of subflows over a plurality of transport links. The router can be configured to designate one of the plurality of transport links for a primary subflow and one or more of the other transport links for one or more subsidiary subflows. In some embodiments, the router updates or changes the transport link for the primary flow, examples of which are described herein (e.g., the methods 800 and 900 described herein with reference to FIGS. 8 and 9, respectively). In some implementations, the router assigns a subflow to a transport link based at least in part on a congestion control algorithm. In certain instances, the congestion control algorithm is tailored to one or more characteristics of the transport link. For example, a congestion control algorithm for satellite links can be used where the transport link uses a satellite.

In block 625, the router transmits the TCP traffic in parallel over the plurality of transport links using the plurality of subflows. In some embodiments, the router transmits the connection-oriented network traffic using secure tunnels over the plurality of transport links. Thus, the router is configured to aggregate the plurality of transport links into a single logical link for the connection-oriented network traffic.

In block 630, the router directs connectionless network traffic to a module configured to implement multipath VPN. In block 635, the router establishes a plurality of tunnels over a corresponding plurality of transport links. In some embodiments, the module configured to implement multipath VPN is configured to assign packets to individual transport links on a packet-by-packet basis. To do so, the module configured to implement multipath VPN can account for current conditions of individual transport links, such as throughput and latency. The module configured to implement multipath VPN may use a round-robin technique weighted in accordance with current network conditions to determine which transport link to use for a particular packet.

In block 640, the router transmits the connectionless network traffic in parallel over the plurality of transport links using the plurality of tunnels. Thus, the router is configured to aggregate the plurality of transport links into a single logical link for the connectionless network traffic.

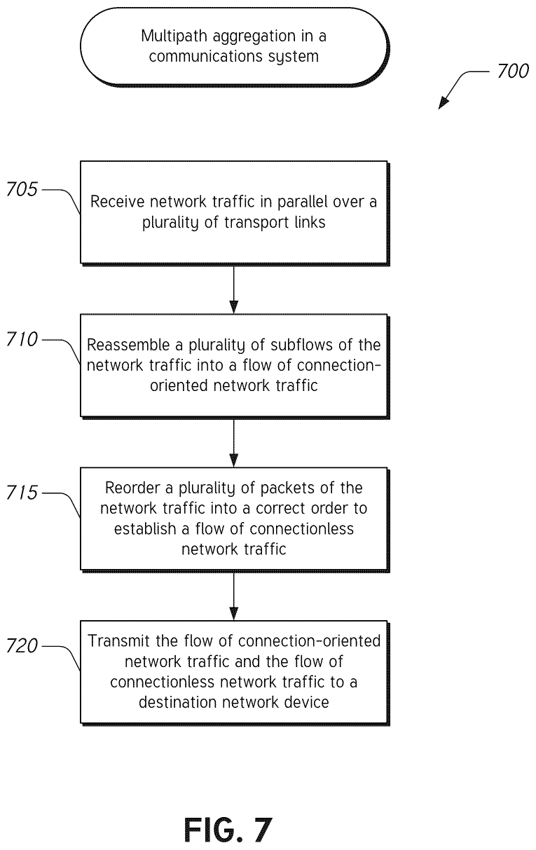

FIG. 7 illustrates a flow chart of an example method 700 for multipath aggregation in a communications system. The method 700 can be performed by a communications system or any component of a communications system (e.g., edge routers, aggregation hubs, or aggregators) disclosed herein. Furthermore, any step or portion of a step of the method 700 can be performed by any suitable component of the communications system disclosed herein. Similarly, any combination of components of the communications system disclosed herein can perform any step or portion of a step of the method 700. However, for ease of description, the method 700 is described as being performed by a router, such as any of the routers disclosed herein including the edge router 110, the aggregation hub 130, the edge router 210, the aggregator 230, the edge router 310, the aggregator 430, and the router 570 described herein with reference to FIGS. 1A-5.

In block 705, the router receives network traffic in parallel over a plurality of transport links. In some embodiments, the router receives the network traffic over a plurality of secure tunnels corresponding to the plurality of transport links. The plurality of tunnels can implement any suitable tunneling technology, such as VPN.

In block 710, the router reassembles a plurality of subflows of the network traffic into a flow of connection-oriented network traffic. The router can be configured to connect to a destination network device to establish a network connection for a connection-oriented protocol such as TCP.

In block 715, the router reorders a plurality of packets of the network traffic into a correct order to establish a flow of connectionless network traffic. In some embodiments, the router can be configured to buffer the received packets to enable reordering of the packets. The router can also be configured to control the size of the buffer based at least in part on the latency across the plurality of transport links.

In block 720, the router transmits the connection-oriented network traffic and the connectionless network traffic to a destination network device. The network device can include a user device, a remote server, a destination terminal, or the like. The network device can be associated with a private or public network to which the router is communicatively coupled. In some embodiments, the router provides network address translation to transmit the network traffic to the destination network device. Thus, the router is configured to aggregate the plurality of transport links into a single logical link for the network traffic, regardless of the transport layer protocol.

### Example Methods of Managing MPTCP Subflows

As disclosed herein, an edge router can use Multipath TCP (MPTCP) to aggregate multiple transport links into a single logical connection for connection-oriented network traffic. MPTCP achieves multipath connectivity using the concept of subflows. For example, a TCP session has a primary subflow that is the initial MPTCP subflow setup between a client and a server. Once the primary subflow has been established, additional subflows (secondary or subsidiary subflows) can be added to provide the benefits of multipath connectivity. For example, subflows can be identified during the TCP 3-way handshake. After the handshake, an application can add or remove subflows. Thus, subflows can be used to aggregate multiple standard TCP connections, or the communication paths from one host to another.

However, an issue can arise if the transport link on which the primary subflow is established is disconnected. In this case, when a new TCP session is invoked, MPTCP will wait for establishment of the primary subflow. Since the link is disconnected, this new session will not be established, effectively stalling any new TCP communication flows. In a highly mobile environment, such as a tactical network, this leads to undesirable behaviors. Accordingly, disclosed herein are methods for identifying when a transport link associated with a primary flow of a connection-oriented session has become unavailable and notifying the MPTCP module (or other component managing MPTCP communication) that the transport link has become unavailable. This may be accomplished, for example, by updating routing tables to remove the disconnected transport link. Advantageously, this helps to avoid delays when initiating new connection-oriented network flows. For example, FIGS. 8 and 9 illustrate different approaches for identifying transport links that become disconnected. In a first approach, a routing protocol can be used to determine if the transport link associated with the primary flow is down (e.g., the method 800 of FIG. 8). In a second approach, the radio status of each transport link can be read or determined (e.g., the method 900 of FIG. 9). If a transport link is determined to be down, the routing table can be updated so that new sessions are initiated on a transport link that is still up. In some embodiments, the disclosed methods may also notify the MPTCP component or module that the transport link has been disconnected so MPTCP can be updated to not use the disconnected transport link.

FIG. 8 illustrates a flow chart of an example method 800 for managing MPTCP subflows in a communications system. The method 800 can be performed by any of the routers (e.g., edge routers, aggregation hubs, or aggregators) disclosed herein. Furthermore, any step or portion of a step of the method 800 can be performed by any suitable component of the routers disclosed herein. Similarly, any combination of components of the routers disclosed herein can perform any step or portion of a step of the method 800. However, for ease of description, the method 800 is described as being performed by an edge router, such as any of the edge routers disclosed herein including edge routers 110, 210, 310 of FIGS. 1A-3 or router 570 of FIG. 5.

In block 805, the edge router establishes a connection-oriented (e.g., TCP) session with an aggregation hub, or a network device in communication with the aggregation hub. The edge router is communicatively coupled to the aggregation hub over a plurality of transport links.

In block 810, the edge router establishes an initial subflow through the aggregation hub using one of the plurality of transport links. The initial subflow can be designated the primary subflow. To establish the initial subflow, the edge router uses a routing protocol, such as open shortest path first (OSPF), to assess reachability between the edge router and the aggregation hub. In some implementations, OSPF is coupled with bidirectional forwarding delay (BFD) to assess reachability between the edge router and the aggregation hub. The routing cost for each of the plurality of transport links between the edge router and the aggregation hub can be set to the same value, which allows the routing table within the edge router to see all transport links as equally valid communication paths. For example, the routing table can be configured to allocate an equal cost for each of the transport links prior to establishing the primary subflow. In this case, the MPTCP primary subflow can be initiated on any path.

In block 815, the edge router establishes one or more additional subflows through the aggregation hub using different transport links from the transport link used for the primary subflow. The one or more additional subflows can be designated secondary or subsidiary subflows.

In block 820, the edge router uses the routing protocols to determine when a transport link becomes disconnected from the edge router and/or the aggregation hub. If a communication path is lost (e.g., the corresponding transport link is disconnected), the OSPF hello messages or optional BFD messages will time out. This causes OSPF to remove the communication path that is lost from the routing table as a valid connectivity option between the edge router and the aggregation hub. Thus, when a new TCP session is initiated, this will force a new communication path to be selected for the primary subflow across any of the remaining valid communication paths.

In block 825, the edge router removes any disconnected transport links from the routing table so that new connections use a transport link that is still connected for the primary subflow. The edge router can return to block 805 to initiate a new connection-oriented session that will use a connected transport link for the primary subflow for the new connection-oriented session. If the transport link for the primary subflow of the prior connection-oriented session is still connected, the new connection-oriented session can use the same transport link for the primary subflow. If the transport link for the primary subflow of the prior connection-oriented session is disconnected, the new connection-oriented session can initiate a primary subflow on a different transport link, as described in block 810.

This approach has the benefit that it is agnostic to the underlying transport links. However, given that this approach sends messages to maintain the status of the transport link, there is some overhead on the transport links as part of this approach.

FIG. 9 illustrates a flow chart of another example method 900 for managing MPTCP subflows in a communications system. The method 900 can be performed by any of the routers (e.g., edge routers, aggregation hubs, or aggregators) disclosed herein. Furthermore, any step or portion of a step of the method 900 can be performed by any suitable component of the routers disclosed herein. Similarly, any combination of components of the routers disclosed herein can perform any step or portion of a step of the method 900. However, for ease of description, the method 900 is described as being performed by an edge router, such as any of the edge routers disclosed herein including edge routers 110, 210, 310 of FIGS. 1A-3 or router 570 of FIG. 5.

In block 905, the edge router establishes a connection-oriented session with an aggregation hub, or a network device in communication with the aggregation hub. The edge router is communicatively coupled to the aggregation hub over a plurality of transport links.

In block 910, the edge router establishes an initial subflow through the aggregation hub using one of the plurality of transport links. The initial subflow can be designated the primary subflow. To establish the initial subflow, the edge router communicates with equipment providing the transport links to determine a status of the transport link. For example, the edge router can use the application programming interfaces (APIs) of the transport link equipment, e.g., radios or modems, to query the radio or modem to determine if the equipment has reachability on the network to a remote peer device (e.g., a far end radio or modem). If the radio or modem can successfully reach the remote peer device, then the corresponding transport link is added to the routing table. The routing cost for each of the plurality of transport links between the edge router and the aggregation hub can be set to the same value, which allows the routing table within the edge router to see all transport links as equally valid communication paths. For example, the routing table can be configured to allocate an equal cost for each of the transport links prior to establishing the primary subflow. In this case, the MPTCP primary subflow can be initiated on any path.

In block 915, the edge router establishes one or more additional subflows through the aggregation hub using different transport links from the transport link used for the primary subflow. The one or more additional subflows can be designated secondary or subsidiary subflows.

In block 920, the edge router periodically queries the radios and modems of the plurality of transport links to determine if a transport link is disconnected from the edge router and/or the aggregation hub. If a radio or modem indicates it has lost connectivity, the edge router can remove the corresponding communication path from the routing table so that it is no longer considered a valid connectivity option between the edge router and the aggregation hub. Thus, when a new connection-oriented session is initiated, this will force a new communication path to be selected for the primary subflow across any of the remaining valid communication paths. Thus, the edge router is configured to monitor each of the plurality of transport links to determine whether a transport link has been disconnected from the communications system.

In block 925, the edge router removes any disconnected transport links from the routing table so that new connections use a transport link that is still connected for the primary subflow. The edge router can return to block 905 to initiate a new connection-oriented session with that will use a connected transport link for the primary subflow for the new connection-oriented session. If the transport link for the primary subflow of the prior connection-oriented session is still connected, the new connection-oriented session can use the same transport link for the primary subflow. If the transport link for the primary subflow of the prior connection-oriented session is disconnected, the new connection-oriented session can initiate a primary subflow on a different transport link, as described in block 910.

This approach has the benefit of little or no additional overhead on the transport link. However, this approach utilizes APIs for each radio or modem that is to be used, making it somewhat dependent on the underlying transport link infrastructure.

### Additional Embodiments and Terminology

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill, and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged and certain steps and/or phases may be omitted entirely. Also, the methods described herein are to be understood to be open-ended, such that additional steps and/or phases to those shown and described herein can also be performed.

Some aspects of the systems and methods described herein can advantageously be implemented using, for example, computer software, hardware, firmware, or any combination of computer software, hardware, and firmware. Computer software can comprise computer executable code stored in a computer readable medium (e.g., non-transitory computer readable medium) that, when executed, performs the functions described herein. In some embodiments, computer-executable code is executed by one or more general purpose computer processors. A skilled artisan will appreciate, in light of this disclosure, that any feature or function that can be implemented using software to be executed on a general purpose computer can also be implemented using a different combination of hardware, software, or firmware. For example, such a module can be implemented completely in hardware using a combination of integrated circuits. Alternatively or additionally, such a feature or function can be implemented completely or partially using specialized computers designed to perform the particular functions described herein rather than by general purpose computers.

Multiple distributed computing devices can be substituted for any one computing device described herein. In such distributed embodiments, the functions of the one computing device are distributed (e.g., over a network) such that some functions are performed on each of the distributed computing devices.

Some embodiments may be described with reference to equations, algorithms, and/or flowchart illustrations. These methods may be implemented using computer program instructions executable on one or more computers. These methods may also be implemented as computer program products either separately, or as a component of an apparatus or system. In this regard, each equation, algorithm, block, or step of a flowchart, and combinations thereof, may be implemented by hardware, firmware, and/or software including one or more computer program instructions embodied in computer-readable program code logic. As will be appreciated, any such computer program instructions may be loaded onto one or more computers, including without limitation a general purpose computer or special purpose computer, or other programmable processing apparatus to produce a machine, such that the computer program instructions which execute on the computer(s) or other programmable processing device(s) implement the functions specified in the equations, algorithms, and/or flowcharts. It will also be understood that each equation, algorithm, and/or block in flowchart illustrations, and combinations thereof, may be implemented by special purpose hardware-based computer systems which perform the specified functions or steps, or combinations of special purpose hardware and computer-readable program code logic means.

Furthermore, computer program instructions, such as embodied in computer-readable program code logic, may also be stored in a computer readable memory (e.g., a non-transitory computer readable medium) that can direct one or more computers or other programmable processing devices to function in a particular manner, such that the instructions stored in the computer-readable memory implement the function(s) specified in the block(s) of the flowchart(s). The computer program instructions may also be loaded onto one or more computers or other programmable computing devices to cause a series of operational steps to be performed on the one or more computers or other programmable computing devices to produce a computer-implemented process such that the instructions which execute on the computer or other programmable processing apparatus provide steps for implementing the functions specified in the equation(s), algorithm(s), and/or block(s) of the flowchart(s).

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list. The word “exemplary” is used exclusively herein to mean “serving as an example, instance, or illustration.” Any implementation described herein as “exemplary” is not necessarily to be construed as preferred or advantageous over other implementations.

The disclosure is not intended to be limited to the implementations shown herein. Various modifications to the implementations described in this disclosure may be readily apparent to those skilled in the art, and the generic principles defined herein may be applied to other implementations without departing from the spirit or scope of this disclosure. The teachings of the invention provided herein can be applied to other methods and systems, and are not limited to the methods and systems described above, and elements and acts of the various embodiments described above can be combined to provide further embodiments. Accordingly, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

1. A method for multipath aggregation in a communications system that includes a plurality of transport links between an edge router and an aggregation hub, the method comprising:
receiving, by the edge router or the aggregation hub, network traffic from a network device;
identifying, by the edge router or the aggregation hub, a transport layer protocol associated with the network traffic;
responsive to identifying connection-oriented traffic in the network traffic:
establishing, by the edge router or the aggregation hub, a plurality of subflows over the plurality of transport links; and
transmitting, by the edge router or the aggregation hub, the connection-oriented traffic in parallel over the plurality of transport links using the plurality of subflows; and
responsive to identifying connectionless traffic in the network traffic:
establishing, by the edge router or the aggregation hub, a secure tunnel for each of the plurality of transport links;
determining, by the edge router or the aggregation hub, a transport link of the plurality of transport links for each packet of the connectionless traffic based at least in part on a weighted algorithm comprising weights associated with a congestion level of the associated transport link; and
transmitting, by the edge router or the aggregation hub, the connectionless traffic in parallel over the plurality of transport links using the corresponding plurality of secure tunnels
wherein the congestion level of the associated transport link is determined by querying, by the edge router or the aggregation hub, each radio or modem associated with each transport link of the plurality of transport links,
wherein querying the radio or modem includes determining a perception of the communications system from a point of view of the radio or modem.

2. The method of claim 1, wherein the weighted algorithm is a round-robin weighted algorithm.

3. The method of claim 1 further comprising receiving, by the edge router or the aggregation hub, transmitted network traffic comprising the transmitted connectionless traffic and the transmitted connection-oriented traffic.

4. The method of claim 3 further comprising directing, by the edge router or the aggregation hub, the transmitted connectionless traffic and the transmitted connection-oriented traffic to a destination network device.

5. The method of claim 3 further comprising, after receiving the transmitted network traffic, reordering, by the edge router or the aggregation hub, packets of the transmitted network traffic to match a packet order of the network traffic prior to being transmitted over the plurality of transport links.

6. The method of claim 3 further comprising combining, by the edge router or the aggregation hub, subflows of the transmitted connection-oriented traffic into a transmitted connection-oriented traffic flow.

7. The method of claim 1, wherein the plurality of transport links have a difference in latency that is less than or equal to about 2 seconds.

8. The method of claim 1 further comprising terminating, by the edge router or the aggregation hub, a connection-oriented flow from the network device by acting as an end point for the network device.

9. The method of claim 1, wherein the connection-oriented traffic includes transport control protocol (TCP) traffic.

10. The method of claim 1, wherein the connectionless traffic includes user datagram protocol (UDP) traffic.

11. An edge router in a communications system that includes a plurality of transport links between the edge router and an aggregation hub, the edge router comprising:
a transport layer protocol sorter configured to analyze network traffic received from a network device to determine a transport layer protocol associated with the network traffic;
a multipath transport control protocol (MPTCP) module configured to receive connection-oriented traffic from the transport layer protocol sorter;
a multipath virtual private network (MPVPN) module configured to receive connectionless traffic from the transport layer protocol sorter;
a plurality of network interfaces configured to communicate with the plurality of transport links;
a data store storing computer executable instructions; and
a processor configured to control operation of the data store, the plurality of network interfaces, the transport layer protocol sorter, the MPTCP module, and the MPVPN module, the processor configured execute the computer executable instructions to:
establish a plurality of subflows over the plurality of transport links for the connection-oriented traffic using the MPTCP module;
establish a secure tunnel for each the plurality of transport links using the MPVPN module;
assign packets to individual transport links of the plurality of transport links using one or more congestion control algorithms with at least one congestion control algorithm being specific to an individual transport link based on characteristics of the individual transport link;
transmit the connection-oriented traffic in parallel over the plurality of transport links using the plurality of subflows; and
transmit the connectionless traffic in parallel over the plurality of transport links using the corresponding plurality of secure tunnels,
wherein the characteristics of the individual transport link are determined by querying a radio or modem associated with the individual transport link,
wherein querying the radio or modem includes determining a perception of the communications system from a point of view of the radio or modem.

12. The edge router of claim 11, wherein the connectionless traffic includes user datagram protocol (UDP) traffic.

13. The edge router of claim 11, wherein the connection-oriented traffic includes transport control protocol (TCP) traffic.

14. The edge router of claim 11, wherein execution of the computer executable instructions further causes the processor to terminate a connection-oriented flow with the network device that sent the network traffic to the edge router by acting as an endpoint of the connection-oriented flow for the network device.

15. The edge router of claim 11, wherein execution of the computer executable instructions further causes the processor to assign packets of the network traffic to individual transport links to transmit the network traffic in parallel over the plurality of transport links.

16. An aggregation hub in a communications system that includes a plurality of transport links between an edge router and the aggregation hub, the aggregation hub comprising:
a multipath transport control protocol (MPTCP) module configured to receive a plurality of connection-oriented subflows over the plurality of transport links;
a multipath virtual private network (MPVPN) module configured to receive a plurality of connectionless packets over the plurality of transport links;
a transport layer protocol sorter configured to forward network traffic reassembled by the MPTCP module and the MPVPN module to a destination network device;
a plurality of network interfaces configured to communicate with the plurality of transport links;
a data store storing computer executable instructions; and
a processor configured to control operation of the data store, the plurality of network interfaces, the transport layer protocol sorter, the MPTCP module, and the MPVPN module, the processor configured execute the computer executable instructions to:
reassemble the plurality of connection-oriented subflows to generate a connection-oriented flow using the MPTCP module;
reorder the plurality of connectionless packets to generate a connectionless flow using the MPVPN module; and
forward network traffic to the destination network device, the network traffic comprising the connection-oriented flow and the connectionless flow,
wherein the plurality of connectionless packets is distributed across the plurality of transport links based on characteristics of individual transport links that are determined by querying a radio or modem associated with each individual transport link,
wherein querying the radio or modem includes determining a perception of the communications system from a point of view of the radio or modem.

17. The aggregation hub of claim 16, wherein execution of the computer executable instructions further causes the processor to establish a TCP connection with the destination network device using the MPTCP module.

18. The aggregation hub of claim 16, wherein execution of the computer executable instructions further causes the processor to buffer the plurality of connectionless packets using the MPVPN module prior to reordering the plurality of connectionless packets.

19. The aggregation hub of claim 18, wherein a size of a buffer is adjusted by the MPVPN module based on a latency difference between the plurality of transport links and a throughput of the plurality of transport links.

20. The aggregation hub of claim 16, wherein the connection-oriented flow includes transport control protocol (TCP) flow.

21. The aggregation hub of claim 16, wherein the connectionless flow includes user datagram protocol (UDP) flow.

22. A method of managing multipath transport control protocol (MPTCP) subflows in a communications system that comprises a plurality of transport links between a first router and a second router, the method comprising:
establishing, by the first router, a TCP session with a network device in communication with the second router;
establishing, by the first router, a primary subflow using a first transport link of the plurality of transport links, the primary subflow established using a routing table;
establishing, by the first router, a subsidiary subflow using a second transport link of the plurality of transport links;
monitoring, by the first router, each of the plurality of transport links to determine that a transport link has been disconnected from the communications system; and
responsive to determining that a transport link has been disconnected, removing, by the first router, the disconnected transport link from the routing table,
wherein the first router updates the routing table based on characteristics of individual transport links,
wherein the first router determines the characteristics of individual transport links by querying a radio or modem associated with the individual transport link,
wherein querying the radio or modem includes determining a perception of the communications system from a point of view of the radio or modem.

23. The method of claim 22, wherein the routing table allocates an equal cost for each of the plurality of transport links prior to establishing the primary subflow.

24. The method of claim 22, wherein monitoring each of the plurality of transport links includes implementing one or more routing protocols to send messages over the plurality of transport links to determine that a transport link has been disconnected from the communications system.

25. The method of claim 24, wherein a transport link is determined to have been disconnected responsive to a message of the one or more routing protocols failing to be sent over the corresponding transport link.

26. The method of claim 22, wherein monitoring each of the plurality of transport links includes querying network equipment of each of the plurality of transport links to determine that a corresponding transport link can reach the second router to determine that the corresponding transport link has been disconnected from the communications system.

27. The method of claim 26, wherein a transport link is determined to have been disconnected responsive to the network equipment of the corresponding transport link responding that the network equipment cannot communicate with the second router.
